(19) United States
(12) Patent Application Publication
(10) Pub. No.: US 2011/0310790 A1
(43) Pub. Date: Dec. 22, 2011

(54) WIRELESS COMMUNICATIONS SYSTEM, WIRELESS TERMINAL DEVICE, AND CHANNEL SWITCHING METHOD

(75) Inventor: Satoru Yamaguchi, Nagoya-shi (JP)

(73) Assignee: BUFFALO INC., Nagoya-shi (JP)

(21) Appl. No.: 13/162,590

(22) Filed: Jun. 17, 2011

(30) Foreign Application Priority Data
Jun. 18, 2010 (JP) 2010-138874

(51) Int. Cl. H04W 36/30; H04W 24/00

(52) U.S. Cl. 370/315

(57) ABSTRACT

A throughput measurement section measures network throughput of communications between a wireless device and an access point. A determination section determines whether the measured throughput satisfies a predetermined value. A channel switching section switches channels used for wireless communications between the wireless device and the access point if the determination section determines that the measured throughput does not satisfy the predetermined value.

### CROSS REFERENCE TO RELATED APPLICATION

The disclosure of Japanese Patent Application No. 2010-138874, filed on Jun. 18, 2010, is incorporated herein by reference.

### BACKGROUND OF THE INVENTION

1. Field of the Invention

The present invention relates to multiple-channel wireless communications capable wireless communications systems including wireless relay devices and wireless terminal devices, to the wireless terminal devices included in the wireless communications systems, and to communications-channel switching methods executed by the wireless communications systems.

2. Description of the Background Art

In wireless communications systems that include wireless relay devices and wireless terminal devices carrying out multiple-channel wireless communications, technology in which the wireless relay devices switch the channel used for communications with the wireless terminal devices according to the occurrence rate of received-signal noise has been known to date (cf., for example, Japanese Laid-Open Patent Publication No. 2004-180106 and Japanese Laid-Open Patent Publication No. 10-42353).

However, the process of switching channels used for communications between the wireless relay devices and the wireless terminal devices as performed in the conventional technology is not necessarily satisfactory in terms of accuracy and efficiency. A need is therefore felt to improve over the present situation the channel switching process in order to minimize decline in the speed of communications between the wireless relay devices and the wireless terminal devices.

### SUMMARY OF THE INVENTION

An object of the present invention is to make available a wireless communications system including a wireless relay device and a wireless terminal device that perform multiple-channel wireless communications, the wireless terminal device itself, and a communications-channel switching method executed by the wireless communications system, capable of efficiently minimizing, with a high level of accuracy, decline in the speed of communications between the wireless relay device and the wireless terminal device.

The present invention is directed to: a wireless communications system including a wireless relay device and a wireless terminal device capable of multiple-channel wireless communications; and the wireless terminal device thereof. In order to attain the aforementioned objects, the wireless terminal device of the wireless communications system according to the present invention includes: a throughput measurement section for measuring a throughput of communications with the wireless relay device through a first channel used for communications with the wireless relay device; a determination section for determining whether the throughput measured by the throughput measurement section is greater than or equal to a predetermined level; a terminal-device-side channel switching section for switching the first channel used for communications with the wireless relay device, to a second channel different from the first channel if the determination section determines that the throughput is not greater than or equal to the predetermined level; and a terminal-device-side communications section for transmitting to the wireless relay device switching destination channel information indicating the second channel to which the first channel is switched by the terminal-device-side channel switching section. Further, the wireless relay device of the wireless communications system according to the present invention includes: a relay-device-side communications section for receiving the switching destination channel information from the wireless terminal device; and a relay-device-side channel switching section for switching, to the second channel, the first channel used for communications with the wireless terminal device, according to the switching destination channel information received by the relay-device-side communications section.

The throughput measurement section further measures throughput of communications with the wireless relay device through the second channel in response to the switching from the first channel to the second channel by the terminal-device-side channel switching section. The terminal-device-side channel switching section switches the second channel used for communications with the wireless relay device to a third channel different from the first and the second channels if the determination section determines that the throughput of the second channel is not greater than or equal to the predetermined level. In the present invention, these process steps are repeatedly performed until the throughput becomes greater than or equal to the predetermined level.

Preferably, in a case where the relay-device-side communications section transmits response data to the wireless terminal device through the second or the third channel, in response to the switching from the first channel to the second channel or the third channel by the relay-device-side channel switching section, if the terminal-device-side communications section does not receive the response data through the second or the third channel within a predetermined time period, the terminal-device-side channel switching section switches, to the first channel, the second or the third channel used for communications with the wireless relay device.

Further, it is preferable that the determination section determines that the throughput measured by the throughput measurement section is not greater than or equal to the predetermined level if the ratio of the throughput measured by the throughput measurement section, relative to a throughput upper limit preestablished between the wireless terminal device and the wireless relay device, is less than a predetermined threshold value

The process steps performed by the wireless communications system can be implemented as a channel switching method for switching channels used for wireless communications between a wireless relay device and a wireless terminal device. In the channel switching method, the wireless terminal device carries out steps of: measuring throughput of communications between the wireless relay device and the wireless terminal device through a first channel used for communications with the wireless relay device; determining whether the throughput measured is greater than or equal to a predetermined level; and switching the first channel used for communications between the wireless relay device and the wireless terminal device to a second channel different from the first channel if the throughput is determined to be not greater than or equal to the predetermined level; and transmitting to the wireless relay device switching destination channel information indicating the second channel to which the first channel is switched in the switching step. The wireless relay device carries out steps of: receiving switching destination channel information from the wireless terminal device; and switching to the second channel the first channel used for communications with the wireless terminal device, according to the switching destination channel information.

Further, the channel switching method may be realized in a form of a program for executing each step described above. Furthermore, the program may be stored in a non-transitory computer-readable storage medium.

The present invention is applicable to, for example, a communications device for performing communications including wireless communications over a communications network. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating an exemplary configuration of a wireless communications system according to one embodiment of the present invention;

FIG. 2 is a block diagram illustrating exemplary internal configurations of a wireless device and a terminal PC according to one embodiment of the present invention;

FIG. 3 is a block diagram illustrating an exemplary internal configuration of an access point according to one embodiment of the present invention;

FIG. 4 is a flow chart for explaining the flow of a channel switching process performed by the wireless device;

FIG. 5 is a flow chart for explaining the flow of a MAC address obtaining process performed in Step S100 of FIG. 4;

FIG. 6 is a flow chart for explaining the flow of a throughput calculation process performed in Step S200 of FIG. 4;

FIG. 7 is a flow chart for explaining the flow of a channel setting process performed in Step S400 of FIG. 4;

FIG. 8 is a diagram schematically illustrating an exemplary configuration of a wireless communications system according to a modification of the present invention; and

FIG. 9 is a diagram schematically illustrating an exemplary configuration of a wireless communications system according to another modification of the present invention.

### DESCRIPTION OF THE PREFERRED EMBODIMENTS

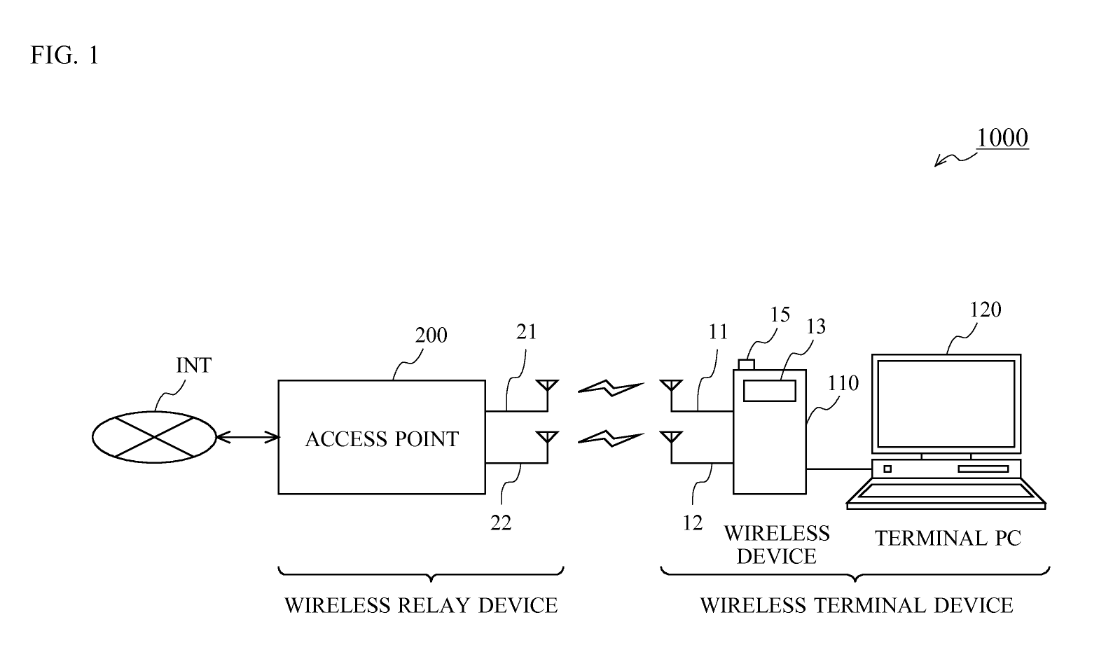

FIG. 1 is a diagram schematically illustrating an exemplary configuration of a wireless communications system 1000 according to one embodiment of the present invention. As shown in FIG. 1, the wireless communications system 1000 includes a wireless device 110 and a terminal PC (personal computer) 120, which act as a wireless terminal device, and an access point 200, which acts as a wireless relay device. The wireless device 110 and the access point 200 according to the present embodiment are each a wireless LAN device compliant with the IEEE (Institute of Electrical and Electronics Engineers) 802.11 standard. The wireless device 110 and the access point 200 are located within a range of each other in which radio waves will reach, and wirelessly relay communications between the communications devices connected to the wireless device 110 and network connected to the access point 200. The wireless device 110 includes two antennas 11 and 12, and the access point 200 includes two antennas 21 and 22. The wireless device 110 and the access point 200 use the antennas 11, 12, 21, and 22 to perform wireless communications according to the MIMO (multiple-input and multiple-output) system. It is to be noted that the wireless device 110 and the access point 200 are able to communicate with each other through multiple channels using different frequency bands.

The wireless device 110 is connected to the terminal PC 120 such as a personal computer which is a client device of the wireless LAN. The access point 200 is connected to the Internet INT. The terminal PC 120 can be connected to the Internet INT by wireless communications between the access point 200 and the wireless device 110.

Further, the wireless device 110 includes: an indicator section 13 for indicating predetermined information to a user; and a button section 15 which may be pressed by a user. The indicator section 13 is implemented as, for example, a colored light-emitting element such as a LED (light emitting diode). Functions of the indicator section 13 and the button section 15 will be described below.

The wireless device 110 may be any device which has a function of relaying communications between the terminal PC 120 and the access point 200. Therefore, examples of the wireless device 110 include, in addition to a dedicated communications relay device, a mobile telephone, a tablet terminal, a game machine, a printer, and a digital camera each having a wireless LAN function. Further, the wireless communications system 1000 may include a plurality of the access points 200, and a plurality of the wireless devices 110. Moreover, the configuration of the wireless communications system 1000 is not limited to a configuration in which the access point 200 is connected to the Internet INT. The configuration of the wireless communications system 1000 may be a configuration in which the access point 200 is connected to a WAN (Wide Area Network), another access point, or a switching hub.

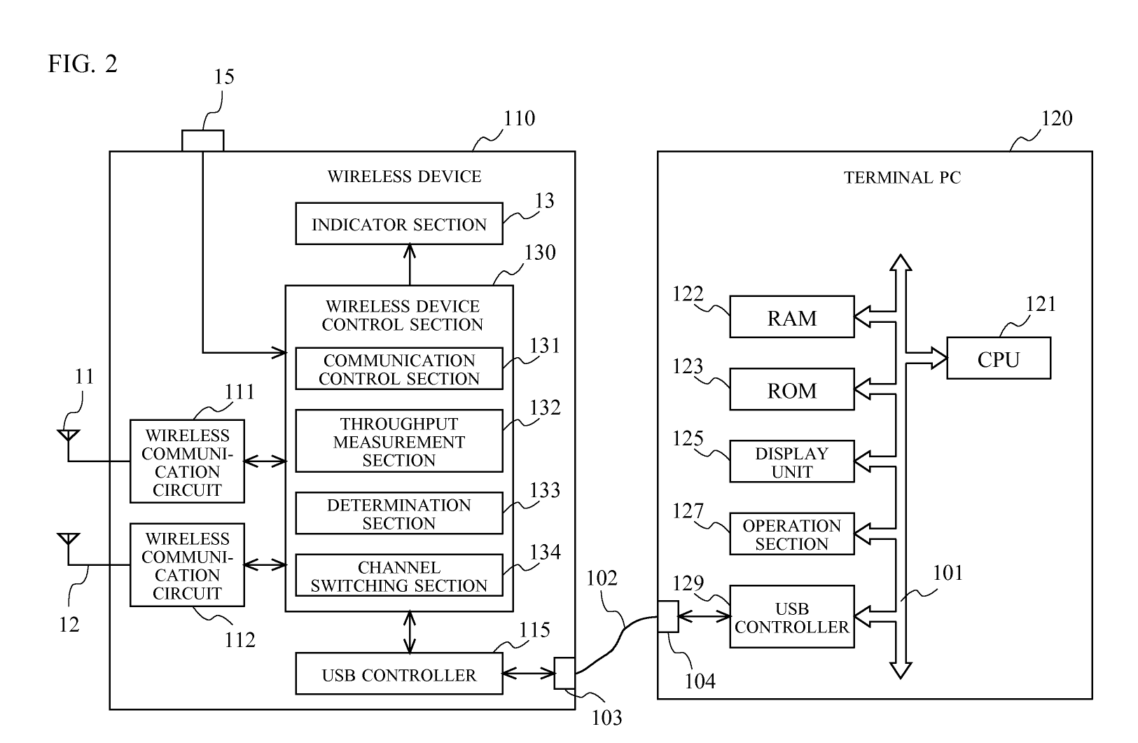

Next, configurations of the wireless device 110 and the terminal PC 120 according to the present embodiment will be described in detail with further reference to FIG. 2. FIG. 2 is a block diagram illustrating exemplary internal configurations of the wireless device 110 and the terminal PC 120 according to one embodiment of the present invention.

The wireless device 110 includes: a wireless device control section 130; two wireless communications circuits 111 and 112; a USB (Universal Serial Bus) controller 115; and a USB port 103. The wireless device control section 130 is connected to each of the wireless communications circuits 111 and 112, the USB controller 115, the indicator section 13, and the button section 15.

The wireless device control section 130 is configured as a CPU (Central Processing Unit) and/or a memory such as an EEPROM (Electrically Erasable and Programmable Read Only Memory), which are not shown. The wireless device control section 130 controls the entirety of the wireless device 110. The wireless device control section 130 functions as a communications control section 131, a throughput measurement section 132, a determination section 133, and a channel switching section 134, by the CPU executing firmware and/or a computer program stored in the memory.

The communications control section 131 controls the wireless communications circuits 111 and 112, and the USB controller 115, to perform data transfer between the wireless device 110, and a communications device such as the terminal PC 120 and the access point 200 which are connected to the wireless device 110. In the present embodiment, the communications control section 131 communicates by using the LLD2 (link layer discovery and diagnostics) protocol which is a Layer 2 protocol. The wireless device 110 exchanges messages with the communications device, and obtains information about the communications device such as a MAC address (media access control address), according to the LLD2 protocol.

The throughput measurement section 132 measures a throughput of communications between the wireless device 110 and the access point 200. The determination section 133 determines whether a channel used for wireless communications between the wireless device 110 and the access point 200 is to be switched, based on the throughput measured by the throughput measurement section 132. The channel switching section 134 switches a channel used for the wireless communications with the access point 200, according to the result of the determination made by the determination section 133. Specific operations of the throughput measurement section 132, the determination section 133, and the channel switching section 134 will be described below in description for a channel switching process.

The wireless communications circuits 111 and 112 are wireless LAN interfaces including the antennas 11 and 12, respectively, and amplifiers (not shown). The wireless communications circuits 111 and 112 each modulate radio wave to be transmitted and demodulate received radio wave, according to an instruction from the wireless device control section 130. For example, the wireless communications circuits 111 and 112 each generate a transmission signal based on transmission data to be transmitted to the access point 200. Specifically, the wireless communications circuits 111 and 112 divides transmission data received from the wireless device control section 130, and generate two sequences of transmission signals corresponding to the two antennas 11 and 12, respectively. The radio waves to be transmitted, which represent two sequences of transmission signals generated, are simultaneously outputted in the same frequency band from the two antennas 11 and 12. Furthermore, the wireless communications circuits 111 and 112 generate reception data based on reception signals which are received through the antennas 11 and 12 from the access point 200. Specifically, the wireless communications circuits 111 and 112 each estimate a transmission matrix for a transmission path between the access point 200 and the wireless device 110, based on distortion between direct wave and reflected wave which are received through the two antennas 11 and 12. The wireless communications circuits 111 and 112 separate and reproduce, from the received radio wave, the two sequences of original transmission signals transmitted from the access point 200 by using the transmission matrix, and combines the two sequences of the reproduced signals, to generate reception data.

The USB controller 115 controls communications between the wireless device control section 130 and a USB device which is connected to the USB port 103 in compliance with the USB standard. In the present embodiment, the terminal PC 120 is connected to the USB port 103 via the USB cable 102.

The terminal PC 120 includes: a CPU 121; a RAM (Random Access Memory) 122; a ROM (Read Only Memory) 123; a display unit 125; an operation section 127; a USB controller 129; and a USB port 104. The CPU 121, the RAM 122, the ROM 123, the display unit 125, the operation section 127, and the USB controller 129 are connected to each other via a bus 101.

The CPU 121 loads a computer program stored in the ROM 123 or an external storage unit (not shown) such as a hard disk drive, into the RAM 122 which is a main storage unit, and executes the computer program to control each component of the terminal PC 120.

The display unit 125 is implemented as an output interface such as a liquid crystal display. The operation section 127 is implemented as an input interface such as a mouse and a keyboard. The USB controller 129 controls communications between the terminal PC 120 and a USB device connected to the USB port 104. In the present embodiment, the wireless device 110 is connected to the USB port 104 via the USB cable 102.

The wireless device 110 and the terminal PC 120 may be connected to each other via a LAN such as a wired LAN or a wireless LAN, or via a bus using a bus cable, as well as via a USB using the USB cable 102 describe above.

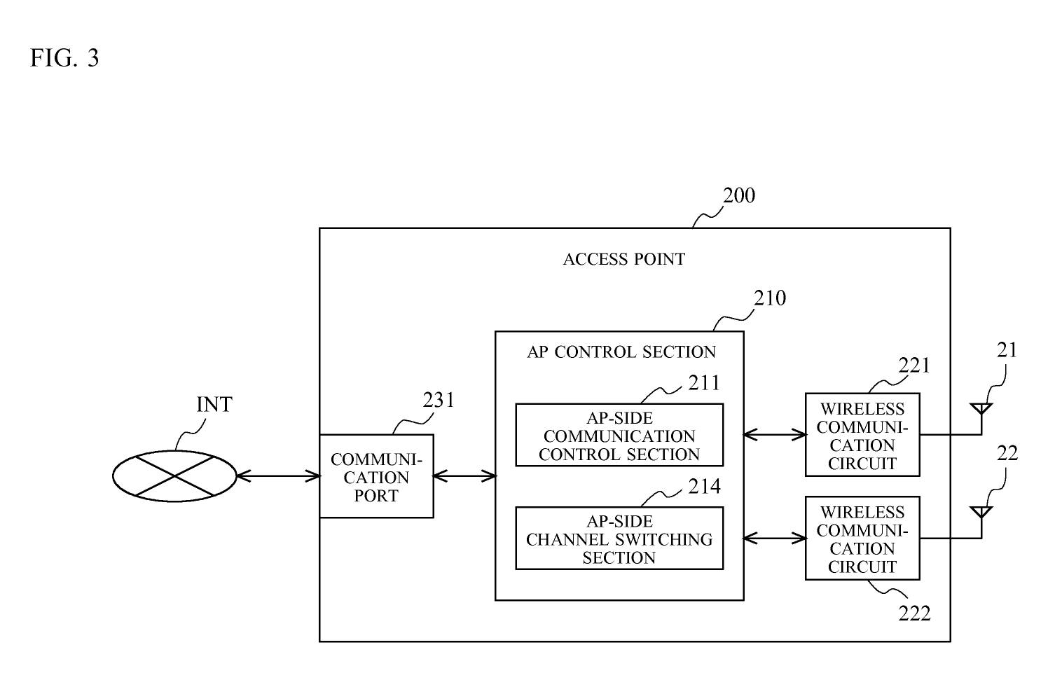

Next, a configuration of the access point 200 according to the present embodiment will be described in detail with further reference to FIG. 3. FIG. 3 is a block diagram illustrating an exemplary internal configuration of the access point 200 according to one embodiment of the present invention. The access point 200 includes: an AP control section 210; two wireless communications circuits 221 and 222; and a communications port 231. The AP control section 210 is connected to each of the wireless communications circuits 221 and 222, and the communications port 231.

The AP control section 210 is configured as a CPU and/or a memory such as an EEPROM, which are not shown, and controls the entirety of the access point 200. The AP control section 210 functions as an AP-side communications control section 211 and an AP-side channel switching section 214, by the CPU executing firmware and/or a computer program stored in the memory.

The AP-side communications control section 211 controls the wireless communications circuits 221 and 222, to perform data transfer between the access point 200 and the wireless device 110. Further, the AP-side communications control section 211 performs data transfer to and from a router (not shown) connected to the communications port 231, in order to allow exchange of information between the access point 200 and a communications device (not shown) through the Internet INT. In the present embodiment, the AP-side communications control section 211 uses the LLD2 protocol, similarly to the wireless device 110. Therefore, the access point 200 exchanges messages with the wireless device 110 in compliance with the LLD2 protocol. When the access point 200 receives a CH switching request described below from the wireless device 110, the AP-side channel switching section 214 switches a channel used for wireless communications with the wireless device 110 to a channel designated in the CH switching request.

The wireless communications circuits 221 and 222 are wireless LAN interfaces which include antennas 21 and 22, respectively, and amplifiers (not shown). The wireless communications circuits 221 and 222 each modulate radio wave to be transmitted, and demodulate received radio wave, according to an instruction from the AP control section 210. The wireless communications circuits 221 and 222 have the same functions and configurations as the wireless communications circuits 111 and 112, respectively, of the wireless device 110, and each generate transmission signal and reception data for wireless communications according to the MIMO system.

In the communications according to the MIMO system, a transmission matrix for a transmission path is estimated based on distortion between direct wave and reflected wave of a transmission signal. Therefore, influence of an obstacle in the transmission path can be reduced in the wireless communications. However, even in the communications according to the MIMO system, when, for example, a device which generates noise in a frequency band used for wireless communications is provided, a sufficient communications speed for communications between the wireless device 110 and the access point 200 may not be obtained in some cases. In this case, it is preferable that the frequency band used for the wireless communications is changed to a band in which influence of noise is small, to perform communications. Therefore, the wireless device 110 according to one embodiment of the present invention performs a channel switching process described below.

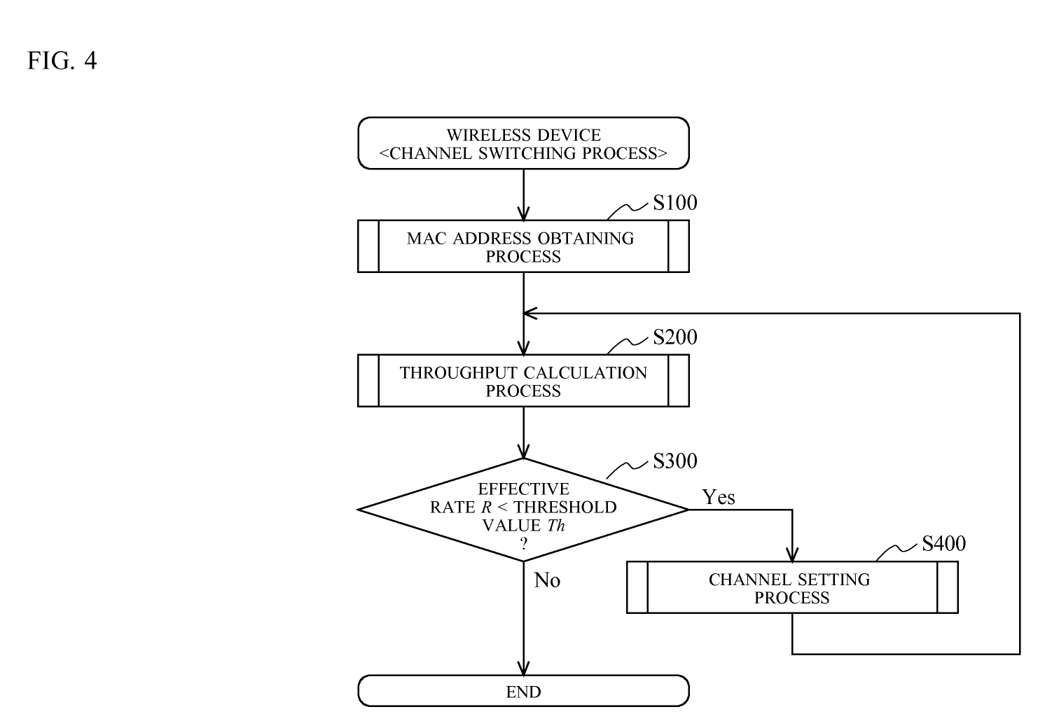

FIG. 4 is a flow chart for explaining the flow of a channel switching process performed by the wireless device 110. In the channel switching process shown in FIG. 4, the status level of communications between the wireless device 110 and the access point 200 is determined according to a message exchange using the LLD2 protocol, and if the communications status does not attain a predetermined level, the frequency band (channel) used for intercommunications is switched.

Firstly, when the wireless device 110 detects a predetermined operation, the wireless device 110 performs a MAC address obtaining process for obtaining MAC addresses from all the communications devices connected to the wireless device 110 (FIG. 4, Step S100). Examples of the predetermined operation include: an operation of a user pressing the button section 15 of the wireless device 110; an operation of the wireless device 110 receiving a process start request from the terminal PC 120; an operation of connecting the terminal PC 120 to the wireless device 110; and an operation of powering the wireless device 110 on.

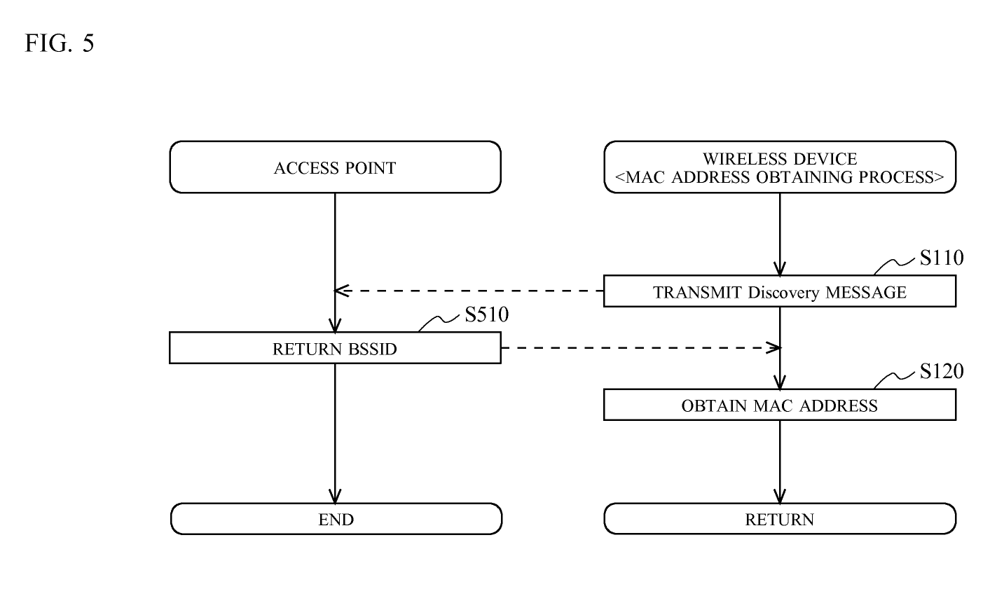

FIG. 5 is a flow chart for explaining the flow of the MAC address obtaining process performed in Step S100 of FIG. 4. In FIG. 5, for convenience of description, process steps performed by the access point 200 are indicated in parallel.

In the MAC address obtaining process, the communications control section 131 of the wireless device control section 130 transmits a message, Discovery message, to all the devices connected to the wireless device 110 (FIG. 5, Step S110). When the AP control section 210 of the access point 200 receives Discovery message from the wireless device 110, a BSSID (basic service set identifier) including the MAC address of the access point 200 is returned to the wireless device 110 (FIG. 5, Step S510). Thus, the wireless device 110 obtains the MAC address of the access point 200 (FIG. 5, Step S120). The wireless device 110 thereafter is able to designate, by means of the MAC address obtained, the access point 200 as a communications partner for sending messages. When the process steps as described above have been performed, the MAC address obtaining process is completed.

When the MAC address obtaining process is completed, and the MAC address of the access point 200 is obtained, the wireless device 110 performs a throughput calculation process for calculating a throughput of communications between the wireless device 110 and the access point 200 (FIG. 4, Step S200).

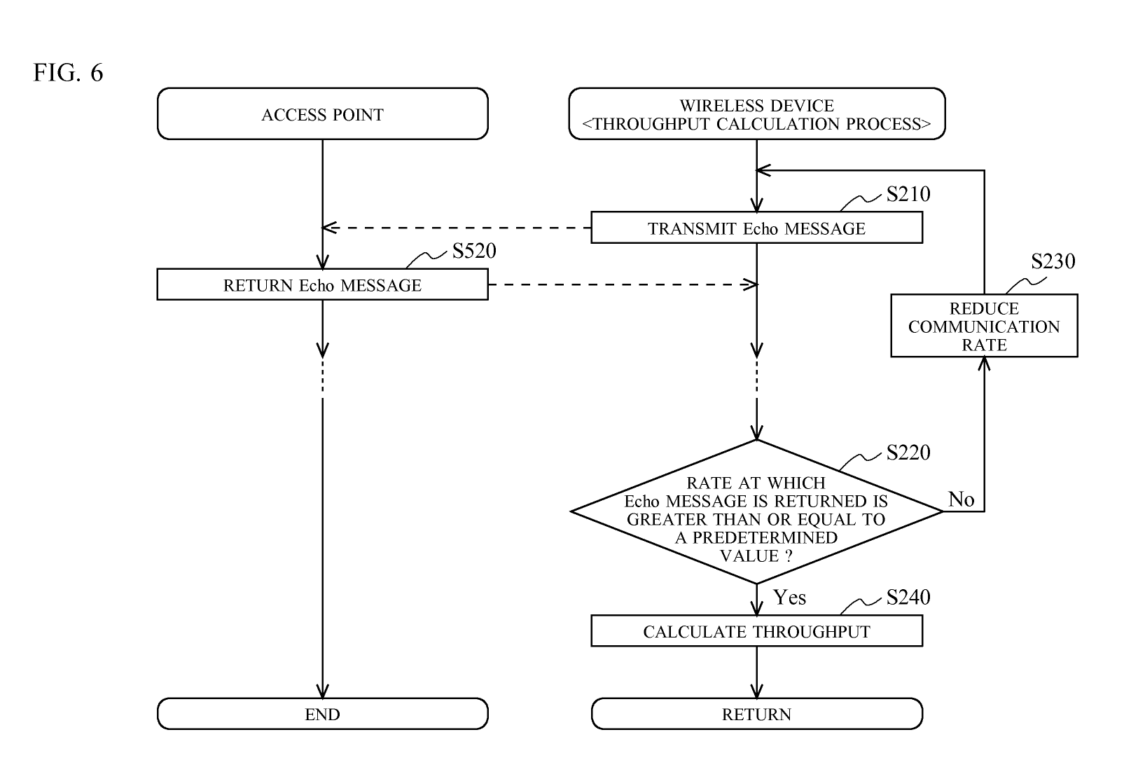

FIG. 6 is a flow chart for explaining the flow of the throughput calculation process performed in Step S200 of FIG. 4. Also in FIG. 6, as in FIG. 5, process steps performed by the access point 200 are indicated in parallel.

In the throughput calculation process, the communications control section 131 of the wireless device control section 130 transmits a message, Echo message, to the access point 200 (FIG. 6, Step S210). Echo message herein is a message stipulated in the LLD2 protocol, has a fixed length, and is transmitted for testing the status of connection between communications devices. When the AP control section 210 of the access point 200 receives Echo message from the wireless device 110, the AP control section 210 returns Echo message to the wireless device 110 as it is (FIG. 6, Step S520). The wireless device 110 and the access point 200 repeat Echo message exchanges a predetermined number n of times (n represents a natural number).

With every exchange of Echo message, the throughput measurement section 132 of the wireless device control section 130 measures the communications time t required for transmitting and returning Echo message one time, and stores the communications times t₁, t₂, . . . , tₙ for n times. Communications time in the present embodiment is the period from when the communications control section 131 starts dividing data representing Echo message so as to generate a transmission signal, to when a process of reproducing, from the received radio wave, the returned Echo message is completed.

In a case where the communications control section 131 does not receive a returned Echo message from the access point 200 when a predetermined time has elapsed after transmission of Echo message to the access point 200, it is determined that Echo message has been lost in the transmission path. The communications control section 131 transmits Echo message anew (FIG. 6, Step S210).

When Echo message exchanges have been performed n times, the throughput measurement section 132 calculates, as Echo-message response rate, a ratio (=m/n×100) of the number m of times (m represents a natural number) the returned Echo message from the access point 200 has been received, relative to the number n of times Echo message has been transmitted. The throughput measurement section 132 determines (FIG. 6, Step S220) whether the calculated Echo-message response rate is greater than or equal to a predetermined value (namely, greater than or equal to a predetermined level). When Echo message response rate is determined (FIG. 6, Step S220: No) to be less than the predetermined value (for example, less than or equal to 90%), the wireless device control section 130 performs a process of reducing the communications rate for communications with the access point 200 (FIG. 6, Step S230). The wireless device control section 130 initializes the communications times t₁, t₂, . . . , tₙ that are stored, and thereafter the wireless device control section 130 performs again Echo message exchange with the access point 200 at the reduced communications rate (FIG. 6, Step S210). Thus, the process of determining Echo-message response rate in Step S220, and the process of reducing the communications rate in Step S230 are repeatedly performed, so that the wireless device 110 and the access point 200 are allowed to communicate with each other at an optimized communications rate.

On the other hand, when Echo message response rate is determined to be greater than or equal to the predetermined value (FIG. 6, Step S220: Yes), the throughput measurement section 132 calculates an effective throughput for communications between the wireless device 110 and the access point 200, according to Echo message exchange between the wireless device 110 and the access point 200 (FIG. 6, Step S240). Specifically, the throughput measurement section 132 calculates a throughput (=b/t) for every one-time exchange of Echo message, by using the stored communications times t₁, t₂, . . . , tₙ and an amount b of data in a MAC frame of Echo message, and obtains, as an effective throughput Vₑ [Mbps], an average of the calculated throughputs. The effective throughput Vₑ may be obtained as an average of all the throughputs calculated from all the stored communications times t₁, t₂, . . . , tₙ, or as an average of the throughputs calculated from a predetermined portion of the stored communications times t₁, t₂, . . . , tₙ.

In the present embodiment, an exemplary case in which the throughput measurement section 132 calculates the throughputs in a MAC layer. However, the throughput measurement section 132 may calculate the throughputs in a layer different from the MAC layer, such as an IP (Internet Protocol) layer, a TCP (Transmission Control Protocol) layer, or a PHY (physical) layer. When the process steps as described above have been performed, the throughput calculation process is completed.

When the effective throughput Vₑ is obtained, and the throughput calculation process is completed, the determination section 133 determines whether a channel used for communications between the wireless device 110 and the access point 200 is to be switched, based on the effective throughput Vₑ (FIG. 4, Step S300). Specifically, the determination section 133 calculates, as an effective rate R, a ratio (Vₑ/Vₜ×100) of the effective throughput Vₑ [Mbps], relative to a theoretical throughput Vₜ [Mbps] of communications between the wireless device 110 and the access point 200, and determines whether the effective rate R is less than a predetermined threshold value Th (for example, 50%). The theoretical throughput Vₜ indicates a maximum throughput representing a maximum processing capability at a linking speed which is preestablished between the wireless device 110 and the access point 200. Any value may be imposed as the threshold value Th in consideration of various empirical values including, for example, a level of reduction in throughput in the case of noise being generated from a noise source.

The determination section 133 may determine whether a channel is to be switched, in various manners as well as a manner in which the effective rate R is used. For example, the determination section 133 may compare the effective throughput Vₑ with a threshold value which is preestablished for each settable linking speed, and determines whether a channel is to be switched, according to whether the effective throughput Ve is greater than the threshold value. Alternatively, the determination section 133 may compare the effective throughput Vₑ with a fixed threshold value regardless of the linking speed, and determines whether a channel is to be switched.

When the effective rate R is determined to be greater than or equal to the threshold value Th (FIG. 4, Step S300:No), the wireless device 110 does not switch a channel used for communications with the access point 200, and ends the channel switching process. On the other hand, when the effective rate R is determined to be less than the threshold value Th (FIG. 4, Step S300: Yes), the wireless device 110 performs the channel setting process for switching a channel used for the communications with the access point 200 (FIG. 4, Step S400).

The wireless device 110 may have a function of indicating, on the indicator section 13, that the effective rate R is less than the threshold value Th. Further, the wireless device 110 may perform the channel setting process when pressing of the button section 15 by a user is detected after it is indicated on the indicator section 13 that the effective rate R is less than the threshold value Th.

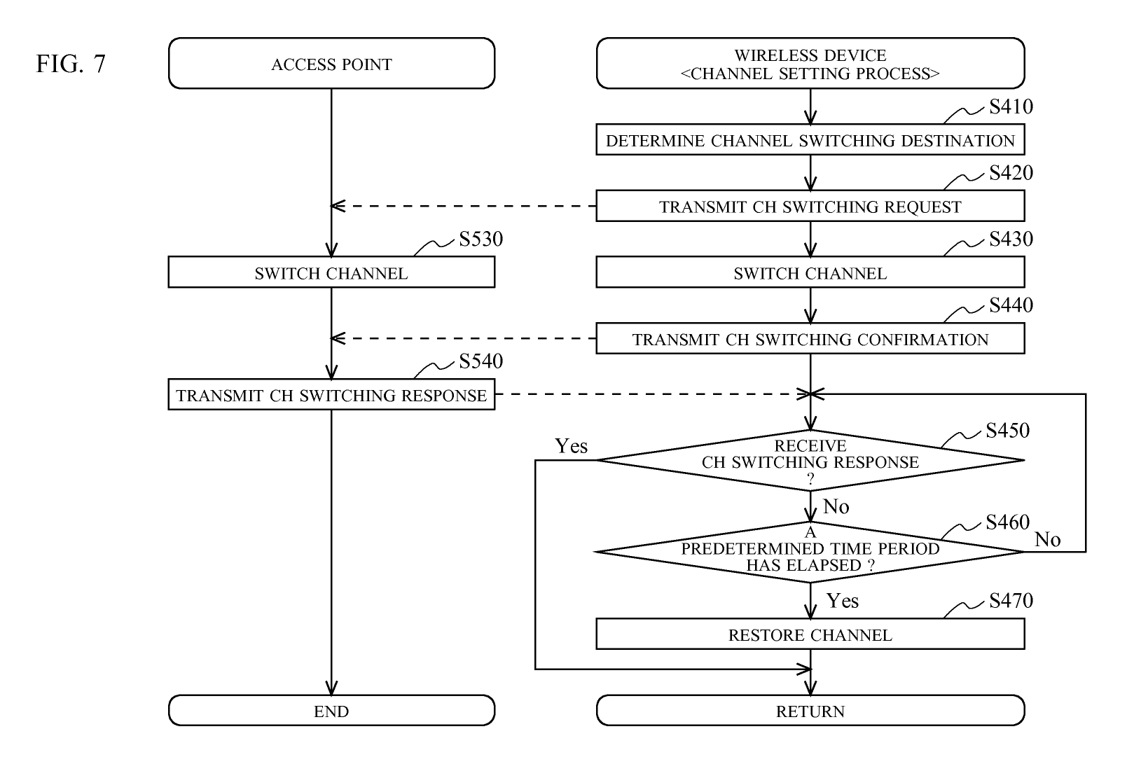

FIG. 7 is a flow chart for explaining the flow of the channel setting process performed in Step S400 of FIG. 4. Also in FIG. 7, as in FIG. 5, process steps performed by the access point 200 are indicated in parallel.

In the channel setting process, the channel switching section 134 of the wireless device control section 130 determines a switching destination of the channel used for the communications with the access point 200 (FIG. 7, Step S410). Specifically, the channel switching section 134 determines, as a switching destination channel which acts as the switching destination, one of the channels different from the original channel, from among multiple channels supported by the wireless device 110 and the access point 200. The original channel herein refers to a channel which is used for communications with the access point 200 at the start of the current process loop.

When the switching destination channel is determined, the communications control section 131 firstly transmits, to the access point 200, a CH switching request which contains information about the switching destination channel (FIG. 7, Step S420). Subsequently, the channel switching section 134 controls the wireless communications circuits 111 and 112, to switch from the original channel to the switching destination channel (FIG. 7, Step S430). The communications control section 131 transmits, to the access point 200, a CH switching confirmation for confirming whether communications with the access point 200 can be made through the switching destination channel (FIG. 7, Step S440).

On the other hand, when the access point 200 receives the CH switching request from the wireless device 110, the AP-side channel switching section 214 of the access point 200 controls the wireless communications circuits 221 and 222, to switch from the original channel, to the switching destination channel designated in the CH switching request (FIG. 7, Step S530). After the switching to the switching destination channel is completed, when the access point 200 receives the CH switching confirmation from the wireless device 110, the AP-side communications control section 211 of the access point 200 transmits, to the wireless device 110, a CH switching response through the switching destination channel (FIG. 7, Step S540). In this configuration, the wireless device 110 can determine whether the wireless device 110 can communicate with the access point 200 through the switching destination channel, according to whether the CH switching response is received from the access point 200.

When the wireless device control section 130 receives the CH switching response from the access point 200 (FIG. 7, Step S450: Yes), it means that communications with the access point 200 can be made through the switching destination channel. Thus, the channel setting process is completed. On the other hand, when the wireless device control section 130 does not receive the CH switching response (FIG. 7, Step S450: No), the wireless device control section 130 waits for a predetermined time period (FIG. 7, Step S460: No). The predetermined time period may be optionally set. In the present embodiment, the predetermined time period is set as a time period from a point of time at which the wireless device 110 transmits the CH switching request, to a point of time at which a predetermined time (for example, 60 seconds) elapses from the transmission of the CH switching request from the wireless device 110.

When the wireless device control section 130 does not receive the CH switching response from the access point 200 even if the wireless device control section 130 waits for the predetermined time period (FIG. 7, Step S460: Yes), the switching destination channel to which the original channel has been switched in Step S430 is restored to the original channel (FIG. 7, Step S470). At this time, the wireless device control section 130 stores, as a switching ineligible channel, the switching destination channel to which the original channel cannot be appropriately switched. Thus, when the wireless device control section 130 determines again a switching destination channel in Step S410, the wireless device control section 130 can avoid selecting, as a potential switching destination channel, the switching ineligible channel to which the original channel cannot be appropriately switched.

For example, the following causes may be assumed when the wireless device 110 cannot receive the CH switching response from the access point 200. Specifically, the CH switching request may not reach the access point 200 due to, for example, the switching destination channel including a noise source. Although the CH switching request reaches the access point 200, a channel is not switched in the access point 200 due to, for example, weather radar being detected in the switching destination channel. Even if the wireless device 110 has difficulty in communications with the access point 200 through the switching destination channel due to these causes, the switching destination channel can be automatically restored to the original channel. Thus, the communications with the access point 200 can be continued again through the original channel. When the process steps as described above have been performed, the channel setting process is completed.

When, in the channel setting process, the original channel is switched to the switching destination channel, or the original channel is determined to be continuously used, the wireless device 110 performs the throughput calculation process again (FIG. 4, Step S200). Specifically, the wireless device 110 calculates a throughput of communications with the access point 200 through a channel having been set in the channel setting process. In this configuration, for example, in a case where the switching destination channel is set as a channel used for communications between the wireless device 110 and the access point 200 in the channel setting process, the throughput measurement section 132 calculates the effective throughput Vₑ for the switching destination channel (FIG. 4, Step S200), and the determination section 133 determines whether the effective rate R for the switching destination channel is less than the threshold value Th (FIG. 4, Step S300). When the effective rate R for the switching destination channel is less than the threshold value Th, the wireless device 110 performs the channel setting process again.

When the channel setting process (FIG. 4, Step S400) is performed for and after the second time due to the effective rate R for the switching destination channel being less than the threshold value Th, a process for selecting and setting another unused switching destination channel, from among the potential channels except for the original channel, the switching destination channel, and the switching ineligible channel, which have been used in the channel setting process, is performed in the process steps described above. The channel setting process is repeatedly performed until the switching destination channel is set which satisfies the effective rate R which is greater than or equal to the threshold value Th.

The original channel, the switching destination channel, and another unused switching destination channel of the present embodiment correspond to a first channel, a second channel, and a third channel, respectively, of claims. Further, the communications control section 131, the AP-side communications control section 211, the channel switching section 134, and the AP-side channel switching section 214 of the present embodiment correspond to a terminal device-side communications section, a relay device-side communications section, a terminal device-side channel switching section, and a relay device-side channel switching section, respectively, of claims.

As described above, in the wireless communications system 1000 according to one embodiment of the present invention, the wireless device 110 measures a throughput of communications with the access point 200, and when the throughput is less than a predetermined level, a channel used for communicating with the access point 200 is switched. Therefore, decline in the speed of communications between the wireless device 110 and the access point 200 can be prevented. For example, even when a channel used for communications with the access point 200 has its throughput reduced due to noise being received from a noise source such as a microwave oven, or due to the channel being used for a wireless terminal device belonging to another network, the channel to be used can be switched to another channel to make communications. Therefore, reduction in throughput can be prevented.

Conventionally, a wireless LAN system is known which switches a channel used for communications with a wireless terminal device according to strength (may be also referred to as received signal strength indicator: RSSI) of radio wave received from the wireless terminal device by a wireless relay device. However, even the conventional wireless LAN system cannot easily detect for noise according to the strength of the received radio wave, when radio wave received by the access point includes noise from a noise source. On the other hand, since the wireless device 110 switches a channel used for communications with the access point 200, according to a level of throughput measured by the wireless device 110, the wireless communications system 1000 according to one embodiment of the present invention can directly link reduction in throughput with switching of channel, thereby enabling reduction in throughput to be effectively prevented.

Modification 1

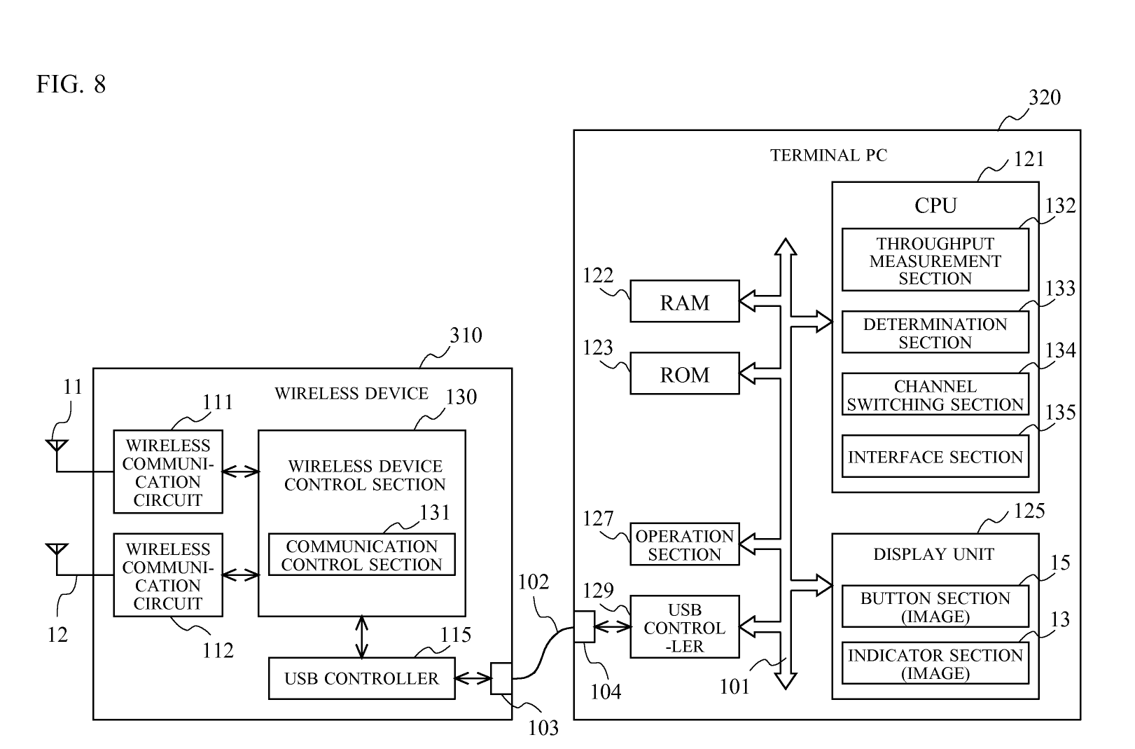

The configuration of the wireless terminal device according to the embodiment as shown in FIG. 2 is an exemplary configuration. The wireless terminal device may have the following configuration. For example, as shown in FIG. 8, the wireless terminal device may be configured such that the terminal PC 320, instead of the wireless device 310, includes the throughput measurement section 132, the determination section 133, the channel switching section 134, the indicator section 13, and the button section 15. In the wireless terminal device shown in FIG. 8, the CPU 121 loads, into the RAM 122, a computer program stored in the ROM 123 or the like, and executes the computer program, to function as the throughput measurement section 132, the determination section 133, and the channel switching section 134. Further, the interface section 135 displays, on the display unit 125, an interface image of the button section 15 and an interface image of the indicator section 13, thereby realizing the indicator section 13 and the button section 15.

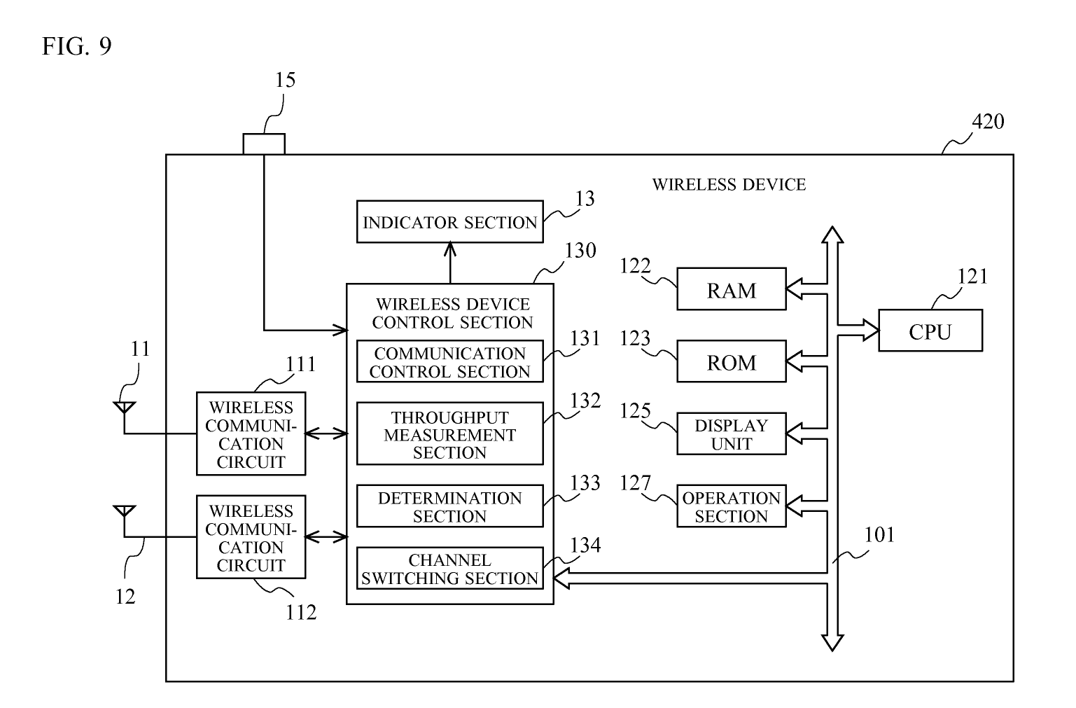

Further, for example, as shown in FIG. 9, a wireless terminal device 420 may be configured in which a wireless device and a terminal PC are integrated with each other. As the wireless terminal device 420 having such a configuration, a terminal PC including a wireless LAN card, or a terminal PC incorporating a wireless LAN module may be used.

Modification 2

In the embodiment described above, an exemplary configuration in which the wireless terminal device includes the indicator section 13 and the button section 15 is described. The indicator section 13 and the button section 15 are not essential for performing the channel switching process. In particular, when the indicator section 13 and the button section 15 are eliminated from the configuration shown in FIG. 8, the interface section 135 is unnecessary.

Modification 3

In the embodiment described above, as shown in FIG. 4, the channel switching process includes the MAC address obtaining process. However, the MAC address obtaining process may be performed at any time separately from the channel switching process by the wireless device 110 or the terminal PC 120.

Modification 4

In the embodiment described above, as shown in FIG. 4, the channel switching process includes the throughput calculation process. However, the channel switching process may include, instead of the throughput calculation process, a process for detecting a parameter, other than the throughput, for determining status of communications between the wireless device 110 and the access point 200. Also in this case, the status of communications is determined according to the detected parameter, and when the status of communications represents a level less than or equal to a predetermined level, a channel is switched, thereby enabling prevention of decline in the speeds of communications between the wireless device 110 and the access point 200. Examples of the parameter for determining the status of communications may include a TCP retransmission rate, and an FCS (Frame Check Sequence) error detection rate.

Modification 5

According to the embodiment described above, in the throughput calculation process shown in FIG. 6, the throughput measurement section 132 calculates the effective throughput Ve by using a throughput of Echo message exchange between the wireless device 110 and the access point 200. However, the throughput measurement section 132 may be configured to calculate the effective throughput Ve, according to a throughput of a process of transmitting and receiving data different than Echo message. However, it is preferable that the throughput of communications is measured by utilizing a communications test function of the communications protocol used, such as a function of exchanging Echo message, since the level of the status of communications can be properly measured with ease.

Modification 6

According to the embodiment described above, in the channel setting process shown in FIG. 7, the channel switching section 134 of the wireless device 110 determines a switching destination channel. However, a switching destination channel may be determined by the wireless relay device. For example, the wireless terminal device including the wireless device 110, the terminal PC 120, and the like transmits, to the access point 200, the CH switching request in which no switching destination channel is designated, when the measured throughput is less than a predetermined level. The access point 200 determines the switching destination channel in response to the CH switching request, and notifies the wireless terminal device of the determined switching destination channel.

Modification 7

In the embodiment described above, the wireless device 110 and the access point 200 communicate with each other according to the LLD2 protocol. However, the wireless device 110 and the access point 200 may be configured to communicate with each other by using another layer 2 protocol, or may be configured to communicate with each other by using a Layer 3 or higher protocol such as the TCP/IP or the FTP (file transfer protocol). When the LLD2 protocol is used, obtaining of the MAC address of the connected device is relatively easy, so that communications for which a connected device is designated can be easily performed.

Modification 8

In the embodiment described above, the wireless device 110 is configured to automatically perform the channel setting process in the channel switching process when the effective rate R is less than the threshold value Th. However, the wireless device 110 may be configured to confirm with a user whether the channel setting process is to be performed. Specifically, the wireless device 110 may be configured such that, when the effective rate R is less than the threshold value Th, the wireless device 110 indicates, on the indicator section 13, that the effective rate R is less than the threshold value Th, and the channel setting process is performed when the wireless device 110 detects pressing of the button section 15 by a user. Further, the wireless device 110 may be configured to perform the channel setting process as necessary when pressing of the button section 15 by a user is detected, regardless of the effective rate R.

In the embodiment described above, the CPU loads, into the RAM, firmware or a computer program stored in the ROM or EEPROM, and executes the firmware or the computer program, to realize each component of the wireless terminal device. However, each component of the present invention may be realized by hardware or software as necessary. Further, when a portion or the entirety of the functions of the present invention is realized by software, the software (computer program) may be stored in a computer-readable storage medium, and provided. In the present invention, examples of the computer-readable storage medium include an internal storage device of a computer such as various types of RAMs and ROMs, and an external storage device, such as a hard disk, secured to the computer, as well as a portable storage medium such as a flexible disk and a CD-ROM.

While the invention has been described in detail, the foregoing description is in all aspects illustrative and not restrictive. It will be understood that numerous other modifications and variations can be devised without departing from the scope of the invention.

What is claimed is:

1. A wireless communications system including a wireless relay device and a wireless terminal device capable of multiple-channel wireless communications, wherein:
the wireless terminal device comprises
a throughput measurement section for measuring throughput of communications with the wireless relay device through a first channel used for communications with the wireless relay device;
a determination section for determining whether the throughput measured by the throughput measurement section is greater than or equal to a predetermined level;
a terminal-device-side channel switching section for switching the first channel used for communications with the wireless relay device to a second channel different from the first channel if the determination section determines that the throughput is not greater than or equal to the predetermined level; and
a terminal-device-side communications section for transmitting to the wireless relay device switching destination channel information indicating the second channel to which the first channel is switched by the terminal-device-side channel switching section; and
the wireless relay device comprises
a relay-device-side communications section for receiving the switching destination channel information from the wireless terminal device; and
a relay-device-side channel switching section for switching to the second channel the first channel used for communications with the wireless terminal device, according to the switching destination channel information received by the relay-device-side communications section.

2. The wireless communications system according to claim 1, wherein:
the throughput measurement section measures throughput of communications with the wireless relay device through the second channel in response to the switching from the first channel to the second channel by the terminal-device-side channel switching section; and
the terminal-device-side channel switching section switches the second channel used for communications with the wireless relay device to a third channel different from the first and the second channels if the determination section determines that the throughput of the second channel is not greater than or equal to the predetermined level.

3. The wireless communications system according to claim 1, wherein:
the relay-device-side communications section transmits response data to the wireless terminal device through the second channel, in response to the switching from the first channel to the second channel by the relay-device-side channel switching section; and
the terminal-device-side channel switching section switches, to the first channel, the second channel used for communications with the wireless relay device if the terminal-device-side communications section does not receive the response data through the second channel within a predetermined time period.

4. The wireless communications system according to claim 2, wherein:
the relay-device-side communications section transmits response data to the wireless terminal device through the third channel, in response to the switching from the second channel to the third channel by the relay-device-side channel switching section; and
the terminal-device-side channel switching section switches, to the first channel, the third channel used for communications with the wireless relay device if the terminal-device-side communications section does not receive the response data through the third channel within a predetermined time period.

5. The wireless communications system according to claim 1, wherein the determination section determines that the throughput measured by the throughput measurement section is not greater than or equal to the predetermined level if the ratio of the throughput measured by the throughput measurement section, relative to a throughput upper limit preestablished between the wireless terminal device and the wireless relay device, is less than a predetermined threshold value.

6. The wireless communications system according to claim 2, wherein the determination section determines that the throughput measured by the throughput measurement section is not greater than or equal to the predetermined level if the ratio of the throughput measured by the throughput measurement section, relative to a throughput upper limit preestablished between the wireless terminal device and the wireless relay device, is less than a predetermined threshold value.

7. The wireless communications system according to claim 3, wherein the determination section determines that the throughput measured by the throughput measurement section is not greater than or equal to the predetermined level if the ratio of the throughput measured by the throughput measurement section, relative to a throughput upper limit preestablished between the wireless terminal device and the wireless relay device, is less than a predetermined threshold value.

8. The wireless communications system according to claim 4, wherein the determination section determines that the throughput measured by the throughput measurement section is not greater than or equal to the predetermined level if the ratio of the throughput measured by the throughput measurement section, relative to a throughput upper limit preestablished between the wireless terminal device and the wireless relay device, is less than a predetermined threshold value.

9. A wireless terminal device capable of multiple-channel wireless communications with a wireless relay device, the wireless terminal device comprising:
a throughput measurement section for measuring throughput of communications with the wireless relay device through a first channel used for communications with the wireless relay device;
a determination section for determining whether the throughput measured by the throughput measurement section is greater than or equal to a predetermined level;
a terminal-device-side channel switching section for switching the first channel used for communications with the wireless relay device to a second channel different from the first channel if the determination section determines that the throughput is not greater than or equal to the predetermined level; and
a terminal-device-side communications section for transmitting to the wireless relay device switching destination channel information indicating the second channel to which the first channel is switched by the terminal-device-side channel switching section.

10. A wireless relay device capable of multiple-channel wireless communications with a wireless terminal device, the wireless relay device comprising:
a relay-device-side communications section for receiving from the wireless terminal device switching destination channel information indicating a second channel different from a first channel while communications are being performed between the wireless relay device and the wireless terminal device through the first channel; and
a relay-device-side channel switching section for switching, to the second channel, the first channel used for communications with the wireless terminal device when the relay-device-side communications section receives the switching destination channel information.

11. A channel switching method for switching channels used for wireless communications between a wireless relay device and a wireless terminal device, comprising:
steps, carried out by the wireless terminal device, of
measuring throughput of communications between the wireless relay device and the wireless terminal device through a first channel used for communications with the wireless relay device,
determining whether the throughput measured is greater than or equal to a predetermined level, and
switching the first channel used for communications between the wireless relay device and the wireless terminal device to a second channel different from the first channel if the throughput is determined to be not greater than or equal to the predetermined level;
transmitting to the wireless relay device switching destination channel information indicating the second channel to which the first channel is switched in the switching step, and
steps, carried out by the wireless relay device, of
receiving switching destination channel information from the wireless terminal device, and
switching to the second channel the first channel used for communications with the wireless terminal device, according to the switching destination channel information.

12. A non-transitory computer-readable storage medium having stored therein a program for switching channels used for wireless communications between a wireless relay device and a wireless terminal device, wherein:
the program causes a processor included in the wireless terminal device to execute
a step of measuring throughput of communications between the wireless relay device and the wireless terminal device through a first channel used for communications with the wireless relay device;
a step of determining whether the throughput measured is greater than or equal to a predetermined level; and
a step of switching the first channel used for communications between the wireless relay device and the wireless terminal device to a second channel different from the first channel if the throughput is determined to be not greater than or equal to the predetermined level;
a step of transmitting to the wireless relay device switching destination channel information indicating the second channel to which the first channel is switched in the switching step, and
the program causes a processor included in the wireless relay device to execute
a step of receiving switching destination channel information from the wireless terminal device; and
a step of switching to the second channel the first channel used for communications with the wireless terminal device, according to the switching destination channel information.
